(19) United States
(12) Patent Application Publication
(10) Pub. No.: US 2023/0102905 A1
(43) Pub. Date: Mar. 30, 2023

(54) NONAQUEOUS ELECTROLYTE ENERGY STORAGE DEVICE

(71) Applicant: GS Yuasa International Ltd., Kyoto-shi, Kyoto (JP)

(72) Inventors: Naoki INOUE, Kyoto (JP); Fumiya KONDO, Kyoto (JP); Takashi KANEKO, Kyoto (JP); Takashi SHIMIZU, Kyoto (JP); Akihito TANOI, Kyoto (JP); Heisuke NISHIKAWA, Kyoto (JP)

(21) Appl. No.: 17/774,537

(22) PCT Filed: Jun. 16, 2020
(86) PCT No.: PCT/JP2020/023525

§ 371 Date: May 5, 2022

(30) Foreign Application Priority Data
Nov. 13, 2019 (JP) 2019-205776

(51) Int. Cl. H01M 50/489; H01M 4/38; H01M 50/417; H01M 10/0525

(52) U.S. Cl. CPC H01M 50/489; H01M 4/386; H01M 4/387; H01M 50/417; H01M 10/0525; H01M 2004/027

(57) ABSTRACT

An aspect of the present invention is a nonaqueous electrolyte energy storage device including: a negative electrode including a negative active material layer with a thickness expansion rate of 10% or more due to charge; and a separator, in which the absolute value (|dR/dP|) of an increase in resistance (dR) to a change in pressure (dP) in pressurization is 0.15 Ω·cm²/MPa or less in the separator impregnated with a measurement electrolyte solution, the measurement electrolyte solution contains an ethylene carbonate and an ethyl methyl carbonate as a solvent, and a lithium hexafluorophosphate as an electrolyte salt, the volume ratio between the ethylene carbonate and the ethyl methyl carbonate is 30:70, and the concentration of the lithium hexafluorophosphate is 1.0 mol/L.

### TECHNICAL FIELD

The present invention relates to a nonaqueous electrolyte energy storage device.

### BACKGROUND ART

Nonaqueous electrolyte secondary batteries typified by lithium ion secondary batteries are widely used for electronic devices such as personal computers and communication terminals, automobiles and the like because these secondary batteries have a high energy density. The nonaqueous electrolyte secondary battery is generally provided with an electrode assembly having a pair of electrodes electrically isolated by a separator, and a nonaqueous electrolyte interposed between the electrodes and is configured for charge-discharge by transferring ions between both the electrodes. Capacitors such as lithium ion capacitors and electric double-layer capacitors are also widely in use as nonaqueous electrolyte energy storage devices except for the secondary batteries.

As such nonaqueous electrolyte energy storage devices, nonaqueous electrolyte energy storage devices including silicon, tin, or a compound containing these elements for a negative active material have been developed (see Patent Documents 1 to 3). The negative active material containing silicon or tin has an advantage of having a larger capacity than that of a carbon material widely used as a negative active material.

### PRIOR ART DOCUMENTS

### Patent Documents

Patent Document 1: JP-A-2015-053152

Patent Document 2: JP-A-2014-120459

Patent Document 3: JP-A-2002-121023

### SUMMARY OF THE INVENTION

### Problems to be Solved by the Invention

The negative active material containing silicon or tin undergoes a large change in volume, associated with charge-discharge, as compared with carbon materials. Thus, the nonaqueous electrolyte energy storage device including such a negative active material has a low capacity retention ratio in a charge-discharge cycle.

The present invention has been made based on the foregoing circumstances, and an object of the invention is to provide a nonaqueous electrolyte energy storage device that includes a negative active material that undergoes a large change in volume in charge-discharge, and has an improved capacity retention ratio in a charge-discharge cycle.

### Means for Solving the Problems

An aspect of the present invention made for solving the problem mentioned above is a nonaqueous electrolyte energy storage device including; a negative electrode including a negative active material layer with a thickness expansion rate of 10% or more due to charge; and a separator, in which the value (dR/dP) of an increase in resistance (dR) to a change in pressure (dP) in pressurization is 0.15 Ω·cm²/MPa or less in the separator impregnated with a measurement electrolyte solution, the measurement electrolyte solution contains an ethylene carbonate and an ethyl methyl carbonate as a solvent, and a lithium hexafluorophosphate as an electrolyte salt, the volume ratio between the ethylene carbonate and the ethyl methyl carbonate is 30:70, and the concentration of the lithium hexafluorophosphate is 1.0 mol/L.

Another aspect of the present invention made for solving the problem mentioned above is a nonaqueous electrolyte energy storage device including; a negative electrode including a negative active material layer with a thickness expansion rate of 10% or more due to charge; and a separator, in which the absolute value (|dR/dP|) of an increase in resistance (dR) to a change in pressure (dP) in pressurization is 0.15 Ω·cm²/MPa or less in the separator impregnated with a measurement electrolyte solution, the measurement electrolyte solution contains an ethylene carbonate and an ethyl methyl carbonate as a solvent, and a lithium hexafluorophosphate as an electrolyte salt, the volume ratio between the ethylene carbonate and the ethyl methyl carbonate is 30:70, and the concentration of the lithium hexafluorophosphate is 1.0 mol/L.

Another aspect of the present invention is a nonaqueous electrolyte energy storage device including; a negative electrode containing silicon or tin; and a separator, in which the value (dR/dP) of an increase in resistance (dR) to a change in pressure (dP) in pressurization is 0.15 Ω·cm²/MPa or less in the separator impregnated with a measurement electrolyte solution, the measurement electrolyte solution contains an ethylene carbonate and an ethyl methyl carbonate as a solvent, and a lithium hexafluorophosphate as an electrolyte salt, the volume ratio between the ethylene carbonate and the ethyl methyl carbonate is 30:70, and the concentration of the lithium hexafluorophosphate is 1.0 mol/L.

Another aspect of the present invention is a nonaqueous electrolyte energy storage device including; a negative electrode containing silicon or tin; and a separator, in which the absolute value (|dR/dP|) of an increase in resistance (dR) to a change in pressure (dP) in pressurization is 0.15 Ω·cm²/MPa or less in the separator impregnated with a measurement electrolyte solution, the measurement electrolyte solution contains an ethylene carbonate and an ethyl methyl carbonate as a solvent, and a lithium hexafluorophosphate as an electrolyte salt, the volume ratio between the ethylene carbonate and the ethyl methyl carbonate is 30:70, and the concentration of the lithium hexafluorophosphate is 1.0 mol/L.

### Advantages of the Invention

The present invention can provide a nonaqueous electrolyte energy storage device that includes a negative active material that undergoes a large change in volume in charge-discharge, and has an improved capacity retention ratio in a charge-discharge cycle.

### BRIEF DESCRIPTION OF THE DRAWINGS

FIG. 1 is an external perspective view showing a nonaqueous electrolyte energy storage device according to an embodiment of the present invention.

FIG. 2 is a schematic diagram showing an energy storage apparatus including a plurality of the nonaqueous electrolyte energy storage devices according to an embodiment of the present invention.

### MODE FOR CARRYING OUT THE INVENTION

An aspect of the present invention is a nonaqueous electrolyte energy storage device (α1) including: a negative electrode including a negative active material layer with a thickness expansion rate of 10% or more due to charge; and a separator, in which the value (dR/dP) of an increase in resistance (dR) to a change in pressure (dP) in pressurization is 0.15 Ω·cm²/MPa or less in the separator impregnated with a measurement electrolyte solution, the measurement electrolyte solution contains an ethylene carbonate (EC) and an ethyl methyl carbonate (EMC) as a solvent, and a lithium hexafluorophosphate (LiPF₆) as an electrolyte salt, the volume ratio between the EC and the EMC is 30:70, and the concentration of the LiPF₆ is 1.0 mol/L.

Another aspect of the present invention is a nonaqueous electrolyte energy storage device (α2) including: a negative electrode including a negative active material layer with a thickness expansion rate of 10% or more due to charge; and a separator, in which the absolute value (|dR/dP|) of an increase in resistance (dR) to a change in pressure (dP) in pressurization is 0.15 Ω·cm²/MPa or less in the separator impregnated with a measurement electrolyte solution, the measurement electrolyte solution contains an ethylene carbonate (EC) and an ethyl methyl carbonate (EMC) as a solvent, and a lithium hexafluorophosphate (LiPF₆) as an electrolyte salt, the volume ratio between the EC and the EMC is 30:70, and the concentration of the LiPF₆ is 1.0 mol/L.

The nonaqueous electrolyte energy storage devices (α1, α2) are nonaqueous electrolyte energy storage devices that include a negative active material that undergoes a large change in volume in charge-discharge, and have an improved capacity retention ratio in a charge-discharge cycle. Although the reason why such an effect occurs is not clear, the following reason is presumed. In the negative active material that changes significantly in volume in charge-discharge, the fact that particles are apt to be cracked or isolated due to repeated expansion and contraction during charge-discharge is known to cause a decrease in capacity. The inventors have, however, assumed that besides such cracks or isolations of the particles, the expansion of the negative active material layer at the time of charge affects the separator, which affects a decrease in the capacity retention ratio. More specifically, in the conventional nonaqueous electrolyte energy storage device in which the negative active material that changes significantly in volume is used, the separator is compressed by the volume expansion of the negative active material layer at the time of charge, and the proportion of holes that serve as a conduction path such as lithium ions in the separator is decreased, thereby making it difficult for the lithium ions and the like to move in the thickness direction of the separator. As a result, the current is assumed to be concentrated in the surface direction of the negative electrode, thereby promoting degradation of the negative electrode. In contrast, in the nonaqueous electrolyte energy storage devices (α1, α2), the change in the resistance of the separator is small even when the separator is pressurized with the expansion of the negative active material layer, because of using the separator that is small in the value (dR/dP) or absolute value (|dR/dP|) of the increase in resistance (dR) to the change in pressure (dP) with the separator impregnated with the measurement electrolyte solution. For this reason, even when the negative active material layer is expanded, the current is assumed to be less likely to be concentrated in the surface direction of the negative electrode, thereby suppressing degradation of the negative electrode, and improving the capacity retention ratio.

The value (dR/dP) of the increase in resistance (dR) to the change in pressure (dP) with the separator impregnated with the measurement electrolyte solution is often a positive value in the case of a separator that has a three-dimensional network structure, but may be a negative value in the case of a separator that has a through-hole structure. The separator that has the through-hole structure is, because of having many continuous holes along the thickness direction of the separator, low in the proportion of holes closed by pressurization of the separator, but the distance of the conduction path such as lithium ions is shortened by the reduced thickness of the separator. Thus, the resistance of the separator impregnated with the measurement electrolyte solution can be reduced. Accordingly, the (dR/dP) of the increase in resistance (dR) to the change in pressure (dP) can be a negative value.

It is to be noted that the thickness expansion rate of the negative active material layer due to charge refers to the increase rate of the average thickness (B) of the negative active material layer charged (SOC: 100%) to the average thickness (A) of the negative active material layer discharged (SOC: 0%), which has a value obtained by the following formula (1).

Expansion Rate (%)={(B−A)/A}×100 (1)

The thickness expansion rate of the negative active material layer due to charge is specifically determined by the following measurement. Laminate-type cells are prepared with the use of a negative electrode for measuring the thickness expansion rate due to charge as a working electrode and metal lithium as a counter electrode. For the electrolyte solutions of the laminate-type cells, an electrolyte solution is used in which a mixed solvent of EC, dimethyl carbonate (DMC), and EMC (30:35:35 in volume ratio) is used as a solvent, LiPF₆ is used as an electrolyte salt, and the content of LiPF₆ is 1.0 mol/L. For charge-discharge, the laminate type cell is sandwiched between two rectangular stainless-steel plates that are larger than the cell area, and four pairs of bolts and nuts in total, arranged at the four corners, are tightened at a torque of 10 cN·m into pressurization. The laminate-type cell subjected to constant current constant voltage charge at a current value of 0.1 C and a potential of 0.02 V vs. Li/Li⁺ for a charge time of 15 hours (SOC: 100%) and the laminate-type cell subjected to constant current discharge at a current value of 0.05 C and a termination potential of 2 V vs. Li/Li⁺ (SOC: 0%) are each disassembled, and the negative electrodes are dried. Thereafter, the thickness of the negative active material layer is measured with a micrometer. In the measurement, the thickness is measured at arbitrary five points of the negative active material layer, and the average value thereof is regarded as an average thickness. In this regard, for the negative electrode, the negative active material layer is provided on one surface of the negative electrode substrate, and in the case of a negative electrode with the negative active material layer provided on both surfaces of the negative electrode substrate, the negative electrode is subjected to a test after removing the negative electrode active material layer on one of the surfaces. It is to be noted that also in the case of using the term “average thickness” for other members and the like, the average thickness similarly refers to the average value of thicknesses measured at arbitrary five points.

In addition, for determining the value (dR/dP) or absolute value (|dR/dP|) of the increase in resistance (dR) to the change in pressure (dP), the pressurization to the separator impregnated with the measurement electrolyte solution refers to pressurization in the thickness direction of the separator. The resistance of the separator impregnated with the measurement electrolyte solution in pressurization is the resistance (Ω·cm²) in the thickness direction of the separator in terms of unit area. In addition, the resistance mentioned above is measured with the separator impregnated with the measurement electrolyte solution. It is to be noted that the measurement electrolyte solution is used for measuring the dR/dP or |dR/dP| of the separator, and the nonaqueous electrolyte for use in the nonaqueous electrolyte energy storage device according to the present invention is not limited to the measurement electrolyte solution, and any nonaqueous electrolyte can be used.

Specifically, the dR/dP or |dR/dP| is a value measured by the following method. For a layered product obtained by sandwiching the measurement object, or separator impregnated with the measurement electrolyte solution between two sheets of aluminum foil as measurement electrodes, the resistance between the measurement electrodes is measured with an alternating-current impedance (1 MHz-1 Hz). The measurement is performed with the layered product pressurized in the thickness direction (lamination direction). The measurement is performed after 1 minute from the start of the pressurization, and the value on the real axis around the resistance component of 0 on the imaginary axis is regarded as the resistance value. The pressurization is first performed at 1.6 MPa and then at 4.1 MPa. In addition, the measurement mentioned above is performed at a temperature of 20° C. The dR/dP is calculated by the following formula (21), or the |dR/dP| is calculated by the following formula (22), where the resistance in the case of pressurization at 1.6 MPa is denoted by R₁, whereas the resistance in the case of pressurization at 4.1 MPa is denoted by R₂.

dR/dP=(R₂−R₁)/(4.1−1.6) (21)

|dR/dP|=|(R₂−R₁)/(4.1−1.6)| (22)

Another aspect of the present invention is a nonaqueous electrolyte energy storage device (β1) including: a negative electrode containing silicon or tin; and a separator, in which the value (dR/dP) of an increase in resistance (dR) to a change in pressure (dP) in pressurization is 0.15 Ω·cm²/MPa or less in the separator impregnated with a measurement electrolyte solution, the measurement electrolyte solution contains an EC and an EMC as a solvent, and LiPF₆ an electrolyte salt, the volume ratio between the EC and the EMC is 30:70, and the concentration of the LiPF₆ is 1.0 mol/L.

Another aspect of the present invention is a nonaqueous electrolyte energy storage device (β2) including: a negative electrode containing silicon or tin; and a separator, in which the absolute value (|dR/dP|) of an increase in resistance (dR) to a change in pressure (dP) in pressurization is 0.15 Ω·cm²/MPa or less in the separator impregnated with a measurement electrolyte solution, the measurement electrolyte solution contains an EC and an EMC as a solvent, and LiPF₆ as an electrolyte salt, the volume ratio between the EC and the EMC is 30:70, and the concentration of the LiPF₆ is 1.0 mol/L.

The nonaqueous electrolyte energy storage devices (β1, β2) are nonaqueous electrolyte energy storage devices that include silicon or tin as a negative active material that undergoes a large change in volume in charge-discharge, and have an improved capacity retention ratio in a charge-discharge cycle. The reason why such an effect is produced is not clear, but the same reason is presumed as in the case of the above-described nonaqueous electrolyte energy storage devices (α1, α2). It is to be noted that silicon or tin may be contained as a simple substance of silicon or tin in the negative electrode, or may be contained as a constituent atom in a compound such as an oxide or an alloy.

The separators of the nonaqueous electrolyte energy storage devices (α1, α2) and nonaqueous electrolyte energy storage devices (β1, β2) are preferably 250 seconds/100 mL or less in air permeability resistance. The use of such a separator with a low air permeability resistance makes the current much less likely to be concentrated in the surface direction of the negative electrode when the negative active material layer is expanded, thereby allowing the capacity retention ratio in a charge-discharge cycle to be further improved.

It is to be noted that the air permeability resistance is a value measured by a “Gurley tester method” in accordance with JIS-P 8117 (2009), which is an average value obtained by measurement at ten different positions.

The separators of the nonaqueous electrolyte energy storage devices (α1, α2) and nonaqueous electrolyte energy storage devices (β1, β2) preferably include a resin that has a glass transition point of 200° C. or lower. The use of such a separator allows a satisfactory shutdown function to be fulfilled in a case such as unexpected heat generation while exhibiting an adequate capacity retention ratio.

The separators of the nonaqueous electrolyte energy storage devices (α1, α2) and nonaqueous electrolyte energy storage devices (β1, β2) preferably contain polyolefin. The use of such a separator allows a satisfactory shutdown function to be fulfilled in a case such as unexpected heat generation while exhibiting an adequate capacity retention ratio.

Hereinafter, the nonaqueous electrolyte energy storage device according to an embodiment of the present invention will be described in detail.

### <Nonaqueous Electrolyte Energy Storage Device>

The nonaqueous electrolyte energy storage device according to an embodiment of the present invention has a positive electrode, a negative electrode, a separator, and a nonaqueous electrolyte. Hereinafter, a secondary battery will be described as an example of the nonaqueous electrolyte energy storage device. The positive electrode and the negative electrode, stacked with the separator interposed therebetween, form an electrode assembly. The electrode assembly may be a wound-type assembly obtained by winding a long positive electrode, a long negative electrode, and a long separator, or may be a stacked-type assembly obtained by stacking a plurality of positive electrodes, a plurality of negative electrodes, and a plurality of separators. The electrode assembly is housed in a case, and the case is filled with the nonaqueous electrolyte. The nonaqueous electrolyte is interposed between the positive electrode and the negative electrode. As the case, a known metal case or resin case or the like, which is usually used as a case of a secondary battery, can be used.

As mentioned above, the positive electrode, the negative electrode, and the separator are stacked to form an electrode assembly, and the electrode assembly is housed in a case. Thus, the separator will be pressurized in the thickness direction by the expansion of the negative electrode in the thickness direction during charge.

### (Positive Electrode)

The positive electrode has a positive electrode substrate and a positive active material layer disposed directly or via an intermediate layer on the positive electrode substrate.

The positive electrode substrate has conductivity. Having “conductivity” means having a volume resistivity of 10⁷ Ω·cm or less that is measured in accordance with JIS-H-0505 (1975), and the term “non-conductivity” means that the volume resistivity is more than 10⁷ Ω·cm. As the material of the positive electrode substrate, a metal such as aluminum, titanium, tantalum, or stainless steel, or an alloy thereof is used. Among these, aluminum or an aluminum alloy is preferable from the viewpoint of electric potential resistance, high conductivity, and costs. Examples of the positive electrode substrate include a foil and a deposited film, and a foil is preferable from the viewpoint of costs. Therefore, the positive electrode substrate is preferably an aluminum foil or an aluminum alloy foil. Examples of the aluminum or aluminum alloy include A1085 and A3003 specified in JIS-H-4000 (2014).

The lower limit of the average thickness of the positive electrode substrate is preferably 5 μm, and more preferably 10 μm. The upper limit of the average thickness of the positive electrode substrate is preferably 50 μm, more preferably 40 μm, still more preferably 30 μm or less. By setting the average thickness of the positive electrode substrate to be equal to or greater than the lower limit, the strength of the positive electrode substrate can be increased. By setting the average thickness of the positive electrode substrate to be equal to or less than the above upper limit, the energy density per volume of the secondary battery can be increased. For these reasons, it is preferable that the average thickness of the positive electrode substrate is equal to or greater than any of the above lower limits and equal to or less than any of the above upper limits.

The intermediate layer is a layer arranged between the positive electrode substrate and the positive active material layer. The configuration of the intermediate layer is not particularly limited, and includes, for example, a resin binder and conductive particles. The intermediate layer contains, for example, conductive particles such as carbon particles to reduce contact resistance between the positive electrode substrate and the positive active material layer.

The positive active material layer contains a positive active material. The positive active material layer is usually formed of a so-called positive composite containing a positive active material. The positive composite forming the positive active material layer may contain optional components such as a conductive agent, a binder, a thickener, and a filler and the like as necessary.

The positive active material can be appropriately selected from known positive active materials usually used for lithium ion secondary batteries and the like. As the positive active material, a material capable of occluding and releasing lithium ions is usually used. Examples of the positive active material include lithium transition metal composite oxides having an α-NaFeO₂-type crystal structure, lithium transition metal composite oxides having a spinel-type crystal structure, polyanion compounds, chalcogenides, and sulfur. Examples of the lithium transition metal composite oxide having an α-NaFeO₂-type crystal structure include Li[LiₓNi₁₋ₓ]O₂ (0≤x<0.5), Li[LiₓNi_{γ}Co(_{1-x-γ)}]O₂ (0≤x<0.5, 0<γ<1), Li[LiₓNi_{γ}Mn_{β}Co_{(1-x-γ-β)}]O₂ (0≤x<0.5, 0<γ, 0<β, 0.5<γ+β<1). Examples of the lithium-transition metal composite oxides having a spinel-type crystal structure include LiₓMn₂O₄ and LiₓNi_{γ}Mn_{(2-γ)}O₄. Examples of the polyanion compounds include LiFePO₄, LiMnPO₄, LiNiPO₄, LiCoPO₄, Li₃V₂(PO₄)₃, Li₂MnSiO₄, and Li₂CoPO₄F. Examples of the chalcogenides include titanium disulfide, molybdenum disulfide, and molybdenum dioxide. Atoms or polyanions in these materials may be partially substituted with atoms or anion species composed of other elements. In the positive active material layer, one of these positive active materials may be used singly, or two or more of these positive active materials may be mixed and used.

The average particle size of the positive active material is preferably 0.1 μm or more and 20 μm or less, for example. By setting the average particle size of the positive active material to be equal to or greater than the upper limit, the positive active material is easily manufactured or handled. By setting the average particle size of the positive active material to be equal to or less than the upper limit, the electron conductivity of the positive active material layer is improved. Here, the term “average particle size” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013).

A crusher and a classifier and the like are used to obtain particles such as a positive active material in a predetermined shape. Examples of a crushing method include a method in which a mortar, a ball mill, a sand mill, a vibratory ball mill, a planetary ball mill, a jet mill, a counter jet mill, a whirling airflow type jet mill, or a sieve or the like is used. At the time of crushing, wet type crushing in the presence of water or an organic solvent such as hexane can also be used. As a classification method, a sieve or a wind force classifier or the like is used based on the necessity both in dry manner and in wet manner.

The lower limit of the content of the positive active material in the positive active material layer is preferably 70% by mass, more preferably 80% by mass, and still more preferably 90% by mass. The upper limit of the content of the positive active material is preferably 98% by mass, and more preferably 96% by mass. By setting the content of the positive active material within the above range, the electric capacity of the secondary battery can be further increased. The content of the positive active material in the positive active material layer can be equal to or greater than any of the above lower limits and equal to or less than any of the above upper limits.

The conductive agent is not particularly limited as long as it is a material exhibiting conductivity. Examples of such a conductive agent include graphite; carbon blacks such as furnace black and acetylene black; metals; and conductive ceramics. Examples of the shape of the conductive agent include a powdery shape and a fibrous shape. Among these, acetylene black is preferable from the viewpoint of electron conductivity and coatability.

The lower limit of the content of the conductive agent in the positive active material layer is preferably 1% by mass, and more preferably 2% by mass. The upper limit of the content of the conductive agent is preferably 10% by mass, and more preferably 5% by mass. By setting the content of the conductive agent within the above range, the electric capacity of the secondary battery can be increased. For these reasons, it is preferable that the content of the conductive agent is equal to or greater than any of the above lower limits and equal to or less than any of the above upper limits.

Examples of the binder include: thermoplastic resins such as fluororesin (polytetrafluoroethylene (PTFE), polyvinylidene fluoride (PVDF), etc.), polyolefin (polyethylene, polypropylene, etc.), an ethylene-vinyl alcohol copolymer, polymethyl methacrylate, a polyethylene oxide, a polypropylene oxide, polyvinyl alcohol, polyacrylate, polymethacrylate, and polyimide; elastomers such as ethylene-propylene-diene rubber (EPDM), sulfonated EPDM, styrene-butadiene rubber (SBR), and fluororubber; and polysaccharide polymers.

The lower limit of the content of the binder in the positive active material layer is preferably 1% by mass, and more preferably 2% by mass. The upper limit of the content of the binder is preferably 10% by mass, and more preferably 5% by mass. When the content of the binder is within the above-described range, the active material can be stably held. For these reasons, it is preferable that the content of the binder is equal to or greater than any of the above lower limits and equal to or less than any of the above upper limits.

Examples of the thickener include polysaccharide polymers such as carboxymethylcellulose (CMC) and methylcellulose. When the thickener has a functional group that is reactive with lithium and the like, the functional group may be deactivated by methylation or the like in advance.

The filler is not particularly limited. Examples of the filler include polyolefins such as polypropylene and polyethylene, silica, alumina, zeolite, glass, and aluminosilicate.

The positive active material layer may contain a typical nonmetal element such as B, N, P, F, Cl, Br, or I, a typical metal element such as Li, Na, Mg, Al, K, Ca, Zn, Ga, or Ge, or a transition metal element such as Sc, Ti, V, Cr, Mn, Fe, Co, Ni, Cu, Mo, Zr, Nb, or W as a component other than the positive active material, the conductive agent, the binder, the thickener, and the filler.

### (Negative Electrode)

The negative electrode has a negative electrode substrate and a negative active material layer disposed directly or via an intermediate layer on the negative electrode substrate. The configuration of the intermediate layer of the negative electrode is not particularly limited, and the intermediate layer can have the same configuration as that of the intermediate layer of the positive electrode.

The negative electrode substrate exhibits conductivity. As the material of the negative electrode substrate, a metal such as copper, nickel, stainless steel, nickel-plated steel, or aluminum, or an alloy thereof is used. Among them, copper or a copper alloy is preferable. Examples of the negative electrode substrate include a foil and a vapor deposited film, and a foil is preferable from the viewpoint of cost. Therefore, the negative electrode substrate is preferably a copper foil or a copper alloy foil. Examples of the copper foil include a rolled copper foil and an electrolytic copper foil.

The lower limit of the average thickness of the negative electrode substrate is preferably 3 μm, and more preferably 5 μm. The upper limit of the average thickness of the negative electrode substrate is preferably 30 μm, and more preferably 20 μm. By setting the average thickness of the negative electrode substrate to be equal to or greater than the above lower limit, the strength of the negative electrode substrate can be increased. By setting the average thickness of the negative electrode substrate to be equal to or less than the above upper limit, the energy density per volume of the secondary battery can be increased. For these reasons, it is preferable that the average thickness of the negative electrode substrate is equal to or greater than any of the above lower limits and equal to or less than any of the above upper limits.

The negative active material layer is usually formed of a so-called negative composite containing a negative active material. The negative composite forming the negative active material layer may contain optional components such as a conductive agent, a binder, a thickener, and a filler as necessary.

According to an embodiment of the present invention, the negative active material layer contains a negative active material containing silicon or tin. Examples of the negative active material containing silicon or tin include a simple substance of silicon or tin, and a compound containing silicon or tin. Examples of the compound containing silicon include a silicon oxide (SiOₓ: 0<x<2, preferably 0.8≤x≤1.2), a silicon nitride, and a silicon carbide. Examples of the compound containing tin include a tin oxide, a tin nitride, and tin alloys (such as Sn₆Cu₅). In addition, the negative active material containing silicon or tin may be a composite material such as a SiO/Si/SiO₂ composite material. As the negative active material containing silicon or tin, pre-doped materials can also be used. More specifically, for example, the negative active material containing silicon or tin may further contain lithium. One of the negative active materials containing silicon or tin can be used, or two or more thereof can be used in mixture. In addition, the negative active material may contain both silicon and tin.

As the negative active material containing silicon or tin, a negative active material containing silicon (a simple substance of silicon or a compound containing silicon) is preferable. In addition, as the negative active material containing silicon or tin, an oxide of silicon or tin is preferable, and a silicon oxide is more preferable.

As the negative active material containing silicon or tin, the surface is preferably coated with a conductive material such as carbon. The use of the negative active material in such a form allows the electron conductivity of the negative active material layer to be enhanced. In the case of the negative active material containing silicon or tin in the form of particles or the like coated with a conductive material, the ratio by mass of the conductive material to the total amount of the negative active material containing silicon or tin and the conductive material coating the negative active material is, for example, preferably 1% by mass or more and 10% by mass or less, more preferably 2% by mass or more and 5% by mass or less.

The shape of the negative active material containing silicon or tin is not particularly limited, and may be a plate shape, a tube shape, or the like, but is preferably a particle shape. The average particle size of the negative active material containing silicon or tin is preferably 0.1 μm or more and 20 μm or less, for example. By setting the average particle size of the negative active material containing silicon or tin to be equal to or greater than the lower limit, the negative active material containing silicon or tin is easily produced or handled. By setting the average particle size of the negative active material containing silicon or tin to be equal to or less than the upper limit, the expansion of the negative active material layer is suppressed, and the capacity retention ratio in a charge-discharge cycle is improved.

The lower limit of the content of the negative active material containing silicon or tin in the whole negative active material is preferably 1% by mass, more preferably 2% by mass, still more preferably 4% by mass, and may be even more preferably 10% by mass. By setting the content of the negative active material containing silicon or tin to be equal to or greater than the above lower limit, the discharge capacity of the secondary battery can be increased. In contrast, the upper limit of the content of the negative active material containing silicon or tin in the whole negative active material may be, for example, 100% by mass, but is preferably 90% by mass, more preferably 80% by mass, still more preferably 60% by mass, and may be even more preferably 40% by mass. By setting the content of the negative active material containing silicon or tin to be equal to or less than the above upper limit, the capacity retention ratio of the secondary battery can be further increased. The content of the negative active material containing silicon or tin in the whole negative active material can be equal to or greater than any of the above lower limits and equal to or less than any of the above upper limits.

The negative active material layer preferably further contains a carbon material as the negative active material. Examples of the carbon material include graphite and non-graphitic carbon, and graphite is preferable. Such a carbon material is contained as the negative active material, thereby further increasing the capacity retention ratio of the secondary battery.

The term “graphite” refers to a carbon material in which an average grid distance (d₀₀₂) of a (002) plane determined by an X-ray diffraction method before charge-discharge or in a discharged state is 0.33 nm or more and less than 0.34 nm. Examples of the graphite include natural graphite and artificial graphite. Artificial graphite is preferable from the viewpoint that a material having stable physical properties can be obtained.

The term “non-graphitic carbon” refers to a carbon material in which the average lattice distance (d₀₀₂) of the (002) plane determined by the X-ray diffraction method before charge-discharge or in the discharged state is 0.34 nm or more and 0.42 nm or less. A crystallite size Lc of the non-graphitic carbon is usually 0.80 to 2.0 nm. Examples of the non-graphitic carbon include hardly graphitizable carbon and easily graphitizable carbon. Examples of the non-graphitic carbon include a material derived from resin, a material derived from petroleum pitch, and a material derived from alcohol.

The “discharged state” in the definition of graphite and non-graphitic carbon refers to a state where an open circuit voltage is 0.7 V or more in a unipolar battery using a negative electrode, containing a carbon material as a negative active material, as a working electrode and using metallic Li as a counter electrode. Since the potential of the metallic Li counter electrode in an open circuit state is substantially equal to an oxidation/reduction potential of Li, the open circuit voltage in the unipolar battery is substantially equal to the potential of the negative electrode containing the carbon material with respect to the oxidation/reduction potential of Li. That is, the fact that the open circuit voltage in the unipolar battery is 0.7 V or more means that lithium ions that can be occluded and released in association with charge-discharge are sufficiently released from the carbon material that is the negative active material.

The lower limit of the content of the carbon material in the whole negative active material may be, for example, 0% by mass, but is preferably 10% by mass, more preferably 20% by mass, still more preferably 40% by mass, and may be even more preferably 60% by mass. By setting the content of the carbon material to be equal to or greater than the above lower limit, the capacity retention ratio of the secondary battery can be further increased. In contrast, the upper limit of the content is preferably 99% by mass, more preferably 98% by mass, still more preferably 96% by mass, and may be even more preferably 90% by mass. By setting the content of the carbon material to be equal to or less than the above upper limit, the content of the negative active material containing silicon or tin can be increased, and the discharge capacity of the secondary battery can be increased. The content of the carbon material in the whole negative active material can be equal to or greater than any of the above lower limits and equal to or less than any of the above upper limits.

As the negative active material, a known negative active material other than the negative active material containing silicon or tin and the carbon material, which is usually used for lithium ion secondary batteries and the like, may be further contained. Examples of such another negative active material include a titanium oxide and a polyphosphoric acid compound. The lower limit of the total content of the negative active material containing silicon or tin and the carbon material in the whole negative active material is, however, preferably 90% by mass, more preferably 99% by mass. In contrast, the upper limit of this total content may be 100% by mass. As described above, the effects of the present invention can be more sufficiently exhibited by using, as the negative active material, only the negative active material containing silicon or tin, or only the negative active material containing silicon or tin and the carbon material.

The lower limit of the content of the negative active material in the negative active material layer is preferably 70% by mass, more preferably 80% by mass, and still more preferably 90% by mass. The upper limit of the content of the negative active material is preferably 98% by mass, more preferably 97% by mass. By setting the content of the negative active material within the above range, the electric capacity of the secondary battery can be further increased.

As the optional components such as a conductive agent, a binder, a thickener, and a filler in the negative active material layer, the same components as those in the positive active material layer can be used. The contents of these optional components in the negative active material layer can be within the ranges described as the contents of the components in the positive active material or the like.

As the binder in the negative active material layer, a fluororesin, a polyacrylate, a polymethacrylate, a styrene-butadiene rubber, an elastomer, or the like is suitably used among the binders described above. These resins are, however, relatively flexible, thus easily causing the expansion of the negative active material containing silicon or tin during charge. Accordingly, in the case of the binder in the negative active material layer from these resins, the advantages of the present invention are more effectively achieved.

The negative active material layer may contain a typical nonmetal element such as B, N, P, F, Cl, Br, or I, a typical metal element such as Li, Na, Mg, Al, K, Ca, Zn, Ga, or Ge, or a transition metal element such as Sc, Ti, V, Cr, Mn, Fe, Co, Ni, Cu, Mo, Zr, Ta, Hf, Nb, or W as a component other than the negative active material, the conductive agent, the binder, the thickener, and the filler.

The lower limit of the average thickness of the negative active material layer in the case of discharge (SOC: 0%) is preferably 10 μm, more preferably 20 μm. By setting the average thickness of the negative active material layer in the case of discharge (SOC: 0%) to be equal to or greater than the above lower limit, the discharge capacity can be increased. The upper limit of the average thickness mentioned above is preferably 300 μm, more preferably 200 μm. The average thickness of the negative active material layer in the case of discharge (SOC: 0%) may be equal to or greater than any of the above lower limits and equal to or less than any of the above upper limits.

According to an embodiment of the present invention, the expansion rate of the negative active material layer is 10% or more. The lower limit of the expansion rate may be 15% or 18%. When the present invention is applied to a nonaqueous electrolyte energy storage device including a negative active material layer that has a high expansion rate as described above, the advantage of the present invention, which is the improved capacity retention ratio in a charge-discharge cycle, can be sufficiently enjoyed. The upper limit of the expansion rate may be, for example, 300%, 150%, or 80%. The expansion rate mentioned above may be equal to or more than any of the above lower limits and equal to or less than any of the above upper limits.

Examples of the negative active material layer with an expansion rate of 10% or more can include a negative active material layer that contains the above-described negative active material containing silicon or tin. In addition, a negative active material layer obtained with the use of aluminum, magnesium, germanium, or the like as the negative active material can also achieve an expansion rate of 10% or more. The suitable form of the negative active material layer with an expansion rate of 10% or more is the same as the form of the negative active material layer that contains the above-described negative active material containing silicon or tin. It is to be noted that the expansion rate tends to be increased as the content of the negative active material containing silicon or tin in the negative active material layer and the average thickness of the negative active material layer are increased.

According to an embodiment of the present invention, the expansion rate of the negative active material layer, based on an uncharged (never charged) state, is preferably 30% or more, more preferably 35% or more, and may be more preferably 40% or more. Also when the present invention is applied to a nonaqueous electrolyte energy storage device including a negative active material layer that has a high expansion rate based on the uncharged state as described above, the advantage of the present invention, which is the improved capacity retention ratio in a charge-discharge cycle, can be sufficiently enjoyed. The upper limit of the expansion rate based on the uncharged state may be, for example, 300%, 150%, or 80%. Examples of the negative active material layer with an expansion rate of 30% or more based on the uncharged state are the same as the above-described examples of the negative active material layer with an expansion rate of 10% or more.

It is to be noted that the expansion rate of the negative active material layer, based on the uncharged state, refers to the increase rate of the average thickness (B) of the negative active material layer charged (SOC: 100%) to the average thickness (A′) of the negative active material layer undischarged (never charged), which has a value obtained by the following formula (1′).

Expansion Rate (%) based on Uncharged State={(B−A′)/A′}×100 (1′)

### (Separator)

The separator typically has a sheet-like porous substrate. The substrate of the separator is typically made of a resin. The separator may have only the substrate, or may further include an inorganic layer layered on the substrate. The separator is infiltrated with the nonaqueous electrolyte. The separator separates the positive electrode and the negative electrode, and holds the nonaqueous electrolyte between the positive electrode and the negative electrode.

The separator is 0.15 Ω·cm²/MPa or less in the value (dR/dP) or absolute value (|dR/dP|) of the increase in resistance (dR) to the change in pressure (dP), obtained when the separator is pressurized and subjected to a resistance measurement with the separator impregnated with the measurement electrolyte solution. The upper limit of the value (dR/dP) or absolute value (|dR/dP|) of the increase in resistance (dR) to the change in pressure (dP) is preferably 0.12 Ω·cm²/MPa, more preferably 0.10 Ω·cm²/MPa, still more preferably 0.08 Ω·cm²/MPa, even more preferably 0.05 Ω·cm²/MPa, even more preferably 0.02 Ω·cm²/MPa. When the value (dR/dP) or absolute value (|dR/dP|) of the increase in resistance (dR) to the change in pressure (dP) is equal to or less than the upper limit, the capacity retention ratio is further enhanced. The lower limit of the value (dR/dP) or absolute value (|dR/dP|) of the increase in resistance (dR) to the change in pressure (dP) may be 0 Ω·cm²/MPa, but is preferably 0.005 Ω·cm²/MPa, and may be more preferably 0.01 Ω·cm²/MPa. The absolute value (|dR/dP|) of the increase in resistance (dR) to the change in pressure (dP) is set to be equal to or greater than the above lower limit, thereby making it possible to reduce the possibility of insufficient followability to the thickness change of the electrode. The absolute value (|dR/dP|) of the increase in resistance (dR) to the change in pressure (dP) may be equal to or more than any of the above lower limits and equal to or less than any of the above upper limits. The lower limit of the value (dR/dP) or absolute value (|dR/dP|) of the increase in resistance (dR) to the change in pressure (dP) may be a negative value, may be −0.15 Ω·cm²/MPa, and is preferably −0.12 Ω·cm²/MPa, more preferably −0.10 Ω·cm²/MPa, still more preferably −0.08 Ω·cm²/MPa, even more preferably −0.05 Ω·cm²/MPa, most preferably −0.02 Ω·cm²/MPa.

The value (dR/dP) and absolute value (|dR/dP|) of the increase in resistance (dR) to the change in pressure (dP) are adjusted depending on the material of the separator, the degree of porosity (porosity or air permeability resistance), and the like. Further, in the case of a hard separator, the separator is considered unlikely to be deformed even by pressurization, and the conduction path of lithium ions and the like is thus considered unlikely to be collapsed. Thus, for example, even with the same air permeability resistance and the like, the value (dR/dP) and absolute value (|dR/dP|) of the increase in resistance (dR) to the change in pressure (dP) tend to be decreased as the separator is harder. For example, even in the case of the same polyethylene separator, however, the hardness varies depending on the degree of polymerization, degree of crystallinity (density), and the like of the polyethylene, and a separator formed from a resin that is relatively high in degree of polymerization and degree of crystallinity has a tendency to become hard.

The resistance (R₂) in the case of pressurization at 4.1 MPa, which is measured at the time of measuring the value (dR/dP) or absolute value (|dR/dP|) of the increase in resistance (dR) to the change in pressure (dP), is, for example, 0.02 Ω·cm² or more and 0.3 Ω·cm² or less. Any separator that has a resistance in such a range at the time of high pressurization is capable of exhibiting sufficient ion conductivity, and more useful as a separator.

The upper limit of the air permeability resistance of the separator may be, for example, 400 seconds/100 mL, but is preferably 300 seconds/100 mL, more preferably 250 seconds/100 mL, still more preferably 200 seconds/100 mL. The lower limit of the air permeability resistance may be, for example, 1 second/100 mL, 10 seconds/100 mL, or 50 seconds/100 mL. The air permeability resistance mentioned above may be equal to or more than any of the above lower limits and equal to or less than any of the above upper limits.

When the air permeability resistance of the separator is set to be equal to or less than the above upper limit, the capacity retention ratio tends to be further improved. As presented in examples described later, when the air permeability resistance falls within the range of, for example, 200 seconds/100 mL or less, the correlation is low between the air permeability resistance and the capacity retention ratio. The improvement in capacity retention ratio merely by the adjustment of a parameter that depends on the porosity, such as air permeability resistance is considered limited in the separator.

For example, a woven fabric, a nonwoven fabric, or a microporous membrane or the like is used as the substrate the separator. Among these substrates, a nonwoven fabric and a microporous membrane are preferable, and a microporous membrane is more preferable. The microporous membrane has advantages such as high strength. The nonwoven fabric has advantages such as a high liquid retaining property.

The resin constituting the substrate of the separator is not particularly limited, and examples thereof include polyolefin, polyester, polyimide, and polyamide (aromatic polyamide, aliphatic polyamide, etc.). The polyolefin is considered also encompassing a copolymer of an olefin and another monomer. Examples of the polyolefin include polyethylene (PE), polypropylene (PP), an ethylene-propylene copolymer, an ethylene-vinyl acetate copolymer, an ethylene-methyl acrylate copolymer, an ethylene-ethyl acrylate copolymer, a polyolefin derivative such as a chlorinated polyethylene, and an ethylene-propylene copolymer.

Among these resins, polyolefin, polyester, and aliphatic polyamide are preferable, polyolefin is more preferable, and PE, PP, and an ethylene-propylene copolymer are still more preferable. These resins, which are relatively low in glass transition point, allow a satisfactory shutdown function to be fulfilled in a case such as unexpected heat generation while exhibiting an adequate capacity retention ratio.

From the viewpoint of such a shutdown function, the upper limit of the glass transition point of the resin included in the substrate of the separator is preferably 200° C., more preferably 100° C., still more preferably 30° C. The lower limit of the glass transition point may be, for example, −200° C. or −150° C. The glass transition point mentioned above may be equal to or more than any of the above lower limits and equal to or less than any of the above upper limits.

Further, the “glass transition point” of the resin is determined by differential scanning calorimetry (DSC). Specifically, the rate of temperature rise is set to 10° C./min with the use of a differential scanning calorimeter (Rigaku Thermo plus DSC 8230). The temperature at which the baseline is shifted is defined as the glass transition point. In the measurement at ordinary temperature or lower, a low-temperature atmosphere is produced with the use of liquid nitrogen.

The lower limit of the average thickness of the substrate of the separator is preferably 5 μm, more preferably 10 μm. The upper limit of the average thickness is preferably 50 μm, more preferably 30 μm. By setting the average thickness of the substrate of the separator to be equal to or greater than the above lower limit, a short circuit between the positive electrode and the negative electrode can be reliably prevented. In addition, by setting the average thickness of the substrate of the separator to be equal to or less than the above upper limit, the energy density can be increased. The average thickness mentioned above may be equal to or more than any of the above lower limits and equal to or less than any of the above upper limits.

The inorganic layer of the separator may include, for example, inorganic particles and a binder.

Examples of the inorganic particles include particles of oxides such as alumina, silica, zirconia, titania, magnesia, ceria, yttria, zinc oxide, and iron oxide, nitrides such as silicon nitride, titanium nitride, and boron nitride, silicon carbide, calcium carbonate, aluminum sulfate, aluminum hydroxide, potassium titanate, talc, kaolin clay, kaolinite, halloysite, pyrophyllite, montmorillonite, sericite, mica, amesite, bentonite, asbestos, zeolite, calcium silicate, and magnesium silicate. Among these particles, particles of alumina, silica, or titania are preferable.

Specific types of the binder for the inorganic layer of the separator may include the examples provided as the binder for the positive active material layer described above.

The lower limit of the average thickness of the inorganic layer of the separator is preferably 1 μm, more preferably 2 μm. In contrast, the upper limit of the average thickness of the inorganic layer is preferably 20 μm, more preferably 10 μm, still more preferably 6 μm. By setting the average thickness of the inorganic layer to be equal to or greater than the above lower limit, the heat resistance or the like of the separator can be increased. By setting the average thickness of the inorganic layer to be equal to or less than the above upper limit, the energy density can be increased. The average thickness mentioned above may be equal to or more than any of the above lower limits and equal to or less than any of the above upper limits.

The lower limit of the average thickness of the separator is preferably 5 μm, more preferably 10 μm. The upper limit of the average thickness is preferably 50 μm, more preferably 30 μm. By setting the average thickness of the separator to be equal to or greater than the above lower limit, a short circuit between the positive electrode and the negative electrode can be reliably prevented. In addition, by setting the average thickness of the separator to be equal to or less than the above upper limit, the energy density can be increased. The average thickness mentioned above may be equal to or more than any of the above lower limits and equal to or less than any of the above upper limits.

### (Nonaqueous Electrolyte)

As the nonaqueous electrolyte, which is not particularly limited, a known nonaqueous electrolyte normally used for a general nonaqueous electrolyte secondary battery (energy storage device) can be used. The nonaqueous electrolyte may be a nonaqueous electrolyte solution containing, for example, a nonaqueous solvent and an electrolyte salt dissolved in the nonaqueous solvent. Other additives may be added to the nonaqueous electrolyte.

As the nonaqueous solvent, it is possible to use a known nonaqueous solvent usually used as a nonaqueous solvent of a general nonaqueous electrolyte for an energy storage device. Examples of the nonaqueous solvent include cyclic carbonate, chain carbonate, ester, ether, amide, sulfone, lactone, and nitrile. Among these, it is preferable to use at least the cyclic carbonate or the chain carbonate, and it is more preferable to use the cyclic carbonate and the chain carbonate in combination. When the cyclic carbonate and the chain carbonate are used in combination, the volume ratio of the cyclic carbonate to the chain carbonate (cyclic carbonate:chain carbonate) is not particularly limited, but is preferably 5:95 or more and 50:50 or less, for example.

Examples of the cyclic carbonate may include EC, propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, catechol carbonate, 1-phenylvinylene carbonate, and 1,2-diphenylvinylene carbonate, and among these chain carbonates, EC, PC, and FEC are preferable.

Examples of the chain carbonate may include DMC, EMC, and diphenyl carbonate (DEC), and among these chain carbonates, EMC is preferable.

As the electrolyte salt, it is possible to use a known electrolyte salt usually used as an electrolyte salt of a general nonaqueous electrolyte for an energy storage device. Examples of the electrolyte salt include a lithium salt, a sodium salt, a potassium salt, a magnesium salt, and an onium salt, and a lithium salt is preferable.

Examples of the lithium salt include inorganic lithium salts such as LiPF₆, LiPO₂F₂, LiBF₄, LiClO₄, and LiN(SO₂F)₂, and lithium salts having a fluorinated hydrocarbon group, such as LiSO₃CF₃, LiN(SO₂CF₃)₂, LiN(SO₂C₂F₅)₂, LiN(SO₂CF₃)(SO₂C₄F₉), LiC(SO₂CF₃)₃ and LiC(SO₂C₂F₅)₃. Among these, an inorganic lithium salt is preferable, and LiPF₆ is more preferable.

The lower limit of the content of the electrolyte salt in the nonaqueous electrolyte is preferably 0.1 mol/L, more preferably 0.3 mol/L, still more preferably 0.5 mol/L, particularly preferably 0.7 mol/L. Meanwhile, the upper limit is not particularly limited, but preferably 2.5 mol/L, more preferably 2 mol/L, still more preferably 1.5 mol/L. The content of the electrolyte salt is preferably equal to or greater than any of the above lower limits and equal to or less than any of the above upper limits.

### <Method for Manufacturing Nonaqueous Electrolyte Energy Storage Device>

The nonaqueous electrolyte energy storage device according to an embodiment of the present invention can be manufactured by a known method. The nonaqueous electrolyte energy storage device can be manufactured by a manufacturing method including, for example, preparing the positive electrode described above, preparing a negative electrode, forming an electrode assembly in which the positive electrode and the negative electrode are alternately superposed by stacking or winding the positive electrode and the negative electrode with a separator interposed between the electrodes, housing the positive electrode and the negative electrode (electrode assembly) in a case, and injecting the nonaqueous electrolyte into the case. A nonaqueous electrolyte energy storage device can be obtained by sealing an injection port after these steps. The separator may be produced by a known method, or a commercially available product may be used.

### <Other Embodiments>

The present invention is not limited to the aforementioned embodiments, and, in addition to the aforementioned embodiments, can be carried out in various modes with alterations and/or improvements being made. For example, it is not necessary to provide an intermediate layer in the positive electrode or the negative electrode.

In the above-described embodiments, an embodiment in which the nonaqueous electrolyte energy storage device is a nonaqueous electrolyte secondary battery has been mainly described, but the nonaqueous electrolyte energy storage device may be other nonaqueous electrolyte energy storage device. Examples of the other nonaqueous electrolyte energy storage device include capacitors (electric double layer capacitors and lithium ion capacitors).

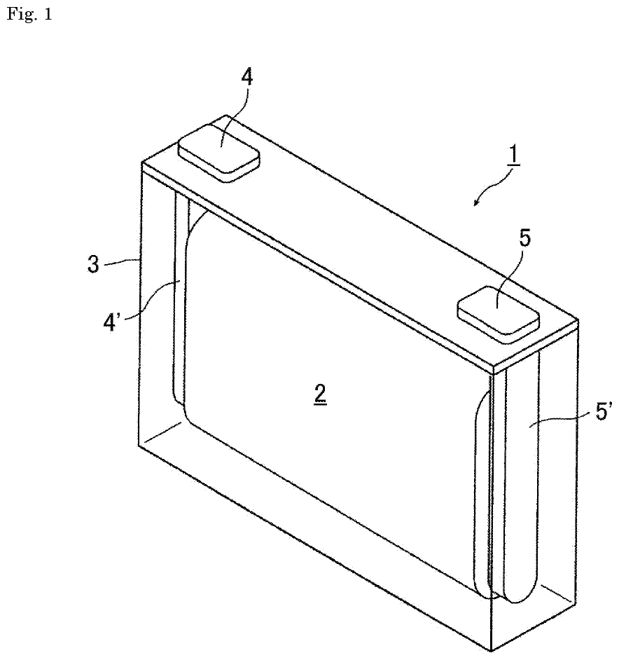

FIG. 1 is a schematic view of a rectangular nonaqueous electrolyte energy storage device 1 (nonaqueous electrolyte secondary battery), which is an embodiment of the nonaqueous electrolyte energy storage device according to the present invention. FIG. 1 is a view showing an inside of a case in a perspective manner. In the nonaqueous electrolyte energy storage device 1 shown in FIG. 1, an electrode assembly 2 is housed in a case 3. The electrode assembly 2 is formed by winding a positive electrode provided with a positive active material and a negative electrode provided with a negative active material via a separator. The positive electrode is electrically connected to a positive electrode terminal 4 through a positive electrode lead 4′, and the negative electrode is electrically connected to a negative electrode terminal 5 through a negative electrode lead 5′.

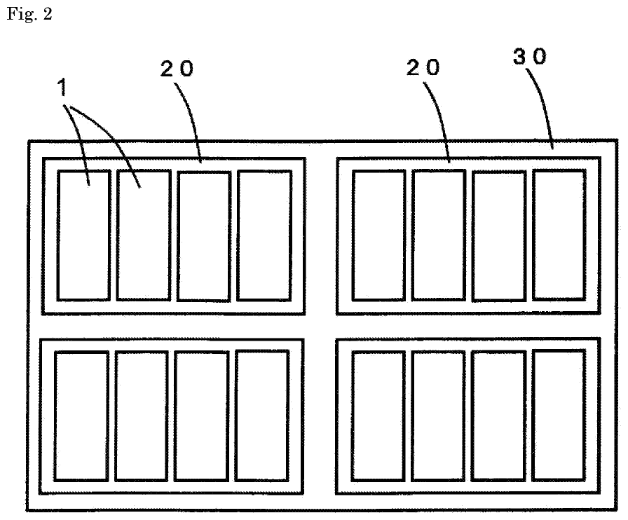

The configuration of the nonaqueous electrolyte energy storage device according to the present invention is not particularly limited, and examples thereof include cylindrical batteries, prismatic batteries (rectangular batteries), and flat batteries. The present invention can also be realized as an energy storage apparatus including a plurality of the nonaqueous electrolyte energy storage devices. FIG. 2 shows an embodiment of an energy storage apparatus. In FIG. 2, an energy storage apparatus 30 includes a plurality of energy storage units 20. Each of the energy storage units 20 includes a plurality of the nonaqueous electrolyte energy storage devices 1. The energy storage apparatus 30 can be mounted as a power source for an automobile such as an electric vehicle (EV), a hybrid vehicle (HEV), a plug-in hybrid vehicle (PHEV), or the like.

### EXAMPLES

Hereinafter, the present invention will be described in more detail with reference to Examples, but the present invention is not limited to the following Examples.

### Example 1

### (Fabrication of Positive Electrode)

Prepared was a positive composite paste containing a positive active material (LiNi_{1/3}Co_{1/3}Mn_{1/3}O₂), acetylene black (AB), and PVDF at 94:3:3 in ratio by mass (in terms of solid content) with N-methylpyrrolidone (NMP) as a dispersion medium. This positive composite paste was applied to an aluminum foil (average thickness: 20 μm) as a positive electrode substrate, and dried to obtain a positive electrode.

### (Fabrication of Negative Electrode)

Silicon oxide (SiO) particles, graphite, and AB were mixed at 20:78:2 in ratio by mass to obtain a mixture containing a negative active material (silicon oxide and graphite). Prepared was a negative composite paste containing the mixture and a sodium polyacrylate (PAANa) at 95:5 in ratio by mass (in terms of solid content) with water as a dispersion medium. This negative composite paste was applied to a copper foil (average thickness: 20 μm) as a negative electrode substrate, and dried to obtain a negative electrode. It is to be noted that particles (carbon content: 2.5% by mass) with a particulate silicon oxide surface coated with carbon as a conductive substance were used for the silicon oxide particles.

The expansion rate of the negative active material layer of the negative electrode obtained was measured by the method described above. The average thickness in an uncharged state (before initial charge-discharge) was 44 μm, the average thickness in charge (SOC: 100%) was 63 μm, and the average thickness in discharge (SOC: 0%) was 53 μm, the expansion rate based on the above formula (1) was 19%, and the expansion rate based on the uncharged state based on the above formula (1′) was 43%.

### (Preparation of Nonaqueous Electrolyte)

Prepared was a nonaqueous electrolyte with LiPF₆ mixed as an electrolyte salt so as to have a content of 1.0 mol/L in a nonaqueous solvent obtained by mixing FEC and EMC at a volume ratio of 10:90.

### (Separator)

As a separator, a separator (average thickness: 25 μm; no inorganic layer) of a microporous substrate made of a polypropylene (glass transition point: about 0° C.) was prepared. The value (dR/dP) and absolute value (|dR/dP|) of the increase in resistance (dR) to the change in pressure (dP) in the separator impregnated with a measurement electrolyte solution were measured by the above-described method. Specifically, the measurement was performed as follows. First, a layered product of: an aluminum foil as a measurement electrode; and the separator to be subjected to the measurement was prepared in the following manner. Prepared were two sheets of aluminum foil (average thickness: 20 μm), each with a flat part of 30 mm×40 mm and a lug part of 10 mm×10 mm connected to one end of the flat part, and an aluminum tab lead welded to the lug part. The two sheets of aluminum foil were layered respectively on both surfaces of the separator of 34 mm×53 mm in size so as not to be brought into contact with each other, and bonded with a polyphenylene sulfide tape to obtain a layered product. The layered product was housed in an outer case made of an aluminum metal-resin composite film, and an upper part (lug part side) of the product was subjected to heat sealing. Subsequently, the measurement electrolyte solution was injected from the lower part of the outer case. Then, after defoaming under reduced pressure, the lower part of the outer case was sealed under reduced pressure by heat sealing to obtain a measurement cell. Both surfaces of the obtained measurement cell were sandwiched between two silicone rubber sheets (35 mm×45 mm, thickness: 2 mm), further sandwiched between two stainless-steel plates (55 mm×55 mm), and pressurized in the thickness direction (lamination direction) with the use of a hydraulic press machine. In the pressurized condition, the resistance between the measurement electrodes was measured with an alternating-current impedance (1 MHz-1 Hz). The measurement was performed after 1 minute from the start of the pressurization, and the value on the real axis around the resistance component of 0 on the imaginary axis was regarded as the resistance value. The pressurization was first performed at 1.6 MPa and then at 4.1 MPa. The measurement mentioned above was performed at a temperature of 20° C. The dR/dP was calculated by the following formula (21), and the |dR/dP| was calculated by the following formula (22), where the resistance in the case of pressurization at 1.6 MPa was denoted by R₁, whereas the resistance in the case of pressurization at 4.1 MPa was denoted by R₂.

dR/dP=(R₂−R₁)/(4.1−1.6) (21)

|dR/dP|=|(R₂−R₁)/(4.1−1.6) (22)

The dR/dP was −0.048 Ω·cm²/MPa, and the |dR/dP| was 0.048 Ω·cm²/MPa. In addition, the air permeability resistance of the separator was 185 seconds/100 mL.

### (Fabrication of Nonaqueous Electrolyte Energy Storage Device)

An electrode assembly was produced by laminating the positive electrode and the negative electrode with the above-mentioned separator interposed between the electrodes. The electrode assembly was housed in a case made from a metal-resin composite film, then the nonaqueous electrolyte was injected into the inside of the case, and then an opening of the case was sealed by heat sealing to obtain a nonaqueous electrolyte energy storage device (secondary battery) of Example 1.

### Example 2 and Comparative Examples 1 and 2

Nonaqueous electrolyte energy storage devices of Example 2 and Comparative Examples 1 and 2 were obtained similarly Example 1 except for using separators with the air permeability resistance and the value (dR/dP) or absolute value (|dR/dP|) of the increase in resistance (dR) to the change in pressure (dP) as shown in Table 1.

### Reference Example 1

A negative electrode including a negative active material layer containing only graphite as a negative active material was obtained similarly to the preparation of the negative electrode in Example 1 except for using a negative composite paste containing graphite, SBR and CMC at 98:1:1 in ratio by mass (in terms of solid content) with water as a dispersion medium.

The expansion rate of the negative active material layer of the negative electrode obtained was measured by the method described above. The average thickness in an uncharged state (before initial charge-discharge) was 71 μm, the average thickness in charge (SOC: 100%) was 90 μm, and the average thickness in discharge (SOC: 0%) was 84 μm, the expansion rate based on the above formula (1) was 7%, and the expansion rate based on the uncharged state based on the above formula (1′) was 27%.

### [Evaluation]

### (Initial Charge-Discharge)

Each of the obtained nonaqueous electrolyte energy storage devices according to Examples 1 and 2 and Comparative Examples 1 and 2 was subjected to initial charge-discharge in the following manner. At 25° C., constant current constant voltage charge was performed at a charge current of 0.1 C to a charge end voltage of 4.2 V for a total charge time of 13 hours. Then, constant current discharge was performed at a discharge current of 0.2 C and an end-of-discharge voltage of 2.5 V. Then, constant current constant voltage charge was performed at a charge current of 0.2 C to a charge end voltage of 4.2 V for a total charge time of 8 hours. Then, constant current discharge was performed at a discharge current of 0.2 C and an end-of-discharge voltage of 2.5 V. Then, constant current constant voltage charge was performed at a charge current of 0.2 C to a charge end voltage of 4.2 V for a total charge time of 8 hours. Then, constant current discharge was performed at a discharge current of 1.0 C and an end-of-discharge voltage of 2.5 V. A rest period of 10 minutes was provided each between the charge and the discharge.

### (Charge-Discharge Cycle Test)

After the initial charge-discharge mentioned above, each of the nonaqueous electrolyte energy storage devices according to Examples 1 and 2 and Comparative Examples 1 and 2 was subjected to a charge-discharge cycle test in the following manner. In a constant temperature bath at 25° C., constant current constant voltage charge was performed at a charge current of 1.0 C and an end-of-charge voltage of 4.2 V. With regard to the charge termination conditions, charge was performed until the charge current reached 0.05 C. After a rest period of 10 minutes, constant current discharge was performed at a discharge current of 1.0 C to an end-of-discharge voltage of 2.5 V, followed by a rest period of 10 minutes. This charge-discharge was performed 100 cycles. The ratio of the discharge capacity of the 100th cycle to the discharge capacity of the 1st cycle in this charge-discharge cycle test was obtained as the capacity retention ratio. Table 1 shows the capacity retention ratios of the nonaqueous electrolyte energy storage devices according to Examples 1 and 2 and Comparative Examples 1 and 2.

### Example 3

### (Fabrication of Positive Electrode)

Prepared was a positive composite paste containing a positive active material (LiNi_{1/2}Co_{1/5}Mn_{3/10}O₂), AB, and PVDF at 93:3.5:3.5 in ratio by mass (in terms of solid content) with NMP as a dispersion medium. This positive composite paste was applied to an aluminum foil (average thickness: 15 μm) as a positive electrode substrate, and dried to obtain a positive electrode.

### (Fabrication of Negative Electrode)

Silicon oxide (SiO) particles and graphite were mixed at 5:95 in ratio by mass to obtain a mixture of a negative active material (silicon oxide and graphite). Prepared was a negative composite paste containing the mixture, SBR, CMC at 97:2:1 in ratio by mass (in terms of solid content) with water as a dispersion medium. This negative composite paste was applied to a copper foil (average thickness: 10 μm) as a negative electrode substrate, and dried to obtain a negative electrode. It is to be noted that particles (carbon content: 5% by mass) with a particulate silicon oxide surface coated with carbon as a conductive substance were used for the silicon oxide particles.

The expansion rate of the negative active material layer of the negative electrode obtained was measured by the method described above. The average thickness in an uncharged state (before initial charge-discharge) was 76 μm, the average thickness in charge (SOC: 100%) was 103 μm, and the average thickness in discharge (SOC: 0%) was 85 μm, the expansion rate based on the above formula (1) was 21%, and the expansion rate based on the uncharged state based on the above formula (1′) was 36%.

### (Preparation of Nonaqueous Electrolyte)

Prepared was a nonaqueous electrolyte with LiPF₆ mixed as an electrolyte salt so as to have a content of 1.0 mol/L in a nonaqueous solvent obtained by mixing EC, PC, and EMC at a volume ratio of 25:5:70.

### (Separator)

As a separator, a separator (average thickness: 24 μm) composed of a microporous substrate (average thickness: 20 μm) made of a polyethylene (glass transition point: about −125° C.) and an inorganic layer (average thickness: 4 μm) was prepared. The value (dR/dP) and absolute value (|dR/dP|) of the increase in resistance (dR) to the change in pressure (dP) in the separator impregnated with a measurement electrolyte solution were measured by the above-described method to obtain dR/dP of 0.013 Ω·cm²/MPa and |dR/dP| of 0.013 Ω·cm²/MPa. In addition, the air permeability resistance of the separator was 150 seconds/100 mL.

### (Fabrication of Nonaqueous Electrolyte Energy Storage Device)

An electrode assembly was produced by laminating the positive electrode and the negative electrode with the above-mentioned separator interposed between the electrodes. The electrode assembly was housed in a case made from a metal-resin composite film, then the nonaqueous electrolyte was injected into the inside of the case, and then an opening of the case was sealed by heat sealing to obtain a nonaqueous electrolyte energy storage device (secondary battery) of Example 3.

### Examples 4 to 6

Nonaqueous electrolyte energy storage devices according to Examples 4 to 6 were obtained similarly to Example 3 except for using separators as shown in Table 2.

### [Evaluation]

### (Initial Charge-Discharge)

Each of the obtained nonaqueous electrolyte energy storage devices according to Examples 3 to 6 was subjected to initial charge-discharge in the following manner. At 25° C., constant current constant voltage charge was performed at a charge current of 0.2 C to a charge end voltage of 4.25 V for a total charge time of 7 hours. Then, constant current discharge was performed at a discharge current of 0.2 C and an end-of-discharge voltage of 2.75 V. Then, constant current constant voltage charge was performed at a charge current of 0.7 C to a charge end voltage of 4.25 V for a total charge time of 3 hours. Then, constant current discharge was performed at a discharge current of 1.0 C and an end-of-discharge voltage of 2.75 V. Then, constant current constant voltage charge was performed at a charge current of 0.7 C to a charge end voltage of 4.25 V for a total charge time of 3 hours. Then, constant current discharge was performed at a discharge current of 1.0 C and an end-of-discharge voltage of 2.75 V. A rest period of 10 minutes was provided each between the charge and the discharge.

### (Charge-Discharge Cycle Test)

After the initial charge-discharge mentioned above, each of the nonaqueous electrolyte energy storage devices according to Examples 3 to 6 was subjected to a charge-discharge cycle test in the following manner. In a constant temperature bath at 45° C., constant current constant voltage charge was performed at a charge current of 0.7 C and an end-of-charge voltage of 4.25 V. With regard to the charge termination conditions, charge was performed until the charge current reached 0.01 C. After a rest period of 10 minutes, constant current discharge was performed at a discharge current of 1.0 C to an end-of-discharge voltage of 2.75 V, followed by a rest period of 10 minutes. This charge-discharge was performed 150 cycles. The ratio of the discharge capacity of the 150th cycle to the discharge capacity of the 1st cycle in this charge-discharge cycle test was obtained as the capacity retention ratio. Table 2 shows the capacity retention ratios of the nonaqueous electrolyte energy storage devices according to Examples 3 to 6.

TABLE 1

| | Separator | | | Evaluation |
|---|---|---|---|---|
| | dR/dP | \|dR/dP\| | Air permeability | Capacity |
| | [Ω · cm²/ | [Ω · cm²/ | resistance | retention |
| | MPa] | MPa] | [s/100 mL] | ratio [%] |
| Example 1 | −0.048 | 0.048 | 185 | 87.8 |
| Example 2 | 0.032 | 0.032 | 90 | 87.5 |
| Comparative | 0.167 | 0.167 | 307 | 75.0 |
| Example 1 | | | | |
| Comparative | 0.357 | 0.357 | 95 | 84.3 |
| Example 2 | | | | |

TABLE 2

| | Separator | | | Evaluation |
|---|---|---|---|---|
| | dR/dP | \|dR/dP\| | Air permeability | Capacity |
| | [Ω · cm²/ | [Ω · cm²/ | resistance | retention |
| | MPa] | MPa] | [s/100 mL] | ratio [%] |
| Example 3 | 0.013 | 0.013 | 150 | 83.6 |
| Example 4 | 0.016 | 0.016 | 120 | 83.4 |
| Example 5 | 0.033 | 0.033 | 150 | 82.6 |
| Example 6 | 0.073 | 0.073 | 300 | 79.8 |

As shown in Table 1, the nonaqueous electrolyte energy storage devices according to Examples 1 and 2 in which the dR/dP or |dR/dP| of the separator (the separator impregnated with the measurement electrolyte solution) has a value of 0.15 Ω·cm²/MPa or less are high in capacity retention ratio. Further, when attention is paid to the air permeability resistance of the separator, the capacity retention ratio has a tendency to decrease when the air resistance is excessively high as in Comparative Example 1, while the result that the capacity retention ratio is better as the air permeability resistance is lower is not obtained unlike the relationship between Example 1 and Comparative Example 2. More specifically, it has been found that because there is a limit on improving the capacity retention ratio by adjusting the degree of porosity such as the air permeability resistance of the separator, the capacity retention ratio can be further improved by using a separator designed or selected based on the value (dR/dP) or absolute value (|dR/dP|) of the increase in resistance (dR) to the change in pressure (dP).

The charge-discharge cycle test according to each of examples in Table 2 was performed under severer conditions in terms of temperature, the number of cycles, and the like than the charge-discharge cycle test according to each of the examples and comparative examples in Table 1. As shown in Table 2, it has been found that when the value of the dR/dP or |dR/dP| of the separator (the separator impregnated with the measurement electrolyte solution) is 0.05 Ω·cm²/MPa or less, and further 0.02 Ω·cm²/MPa or less, the capacity retention ratio is increased even in charge-discharge cycle tests under severe conditions.

### INDUSTRIAL APPLICABILITY

The present invention can be applied to a nonaqueous electrolyte energy storage device and the like used as a power source for electronic devices such as personal computers and communication terminals, automobiles, and industrial use and the like.

### DESCRIPTION OF REFERENCE SIGNS

1: nonaqueous electrolyte energy storage device

2: electrode assembly

3: case

4: positive electrode terminal

4′: positive electrode lead

5: negative electrode terminal

5′: negative electrode lead

20: energy storage unit

30: energy storage apparatus

1. A nonaqueous electrolyte energy storage device comprising:
a negative electrode including a negative active material layer with a thickness expansion rate of 10% or more due to charge; and
a separator,
wherein a value (dR/dP) or an absolute value (|dR/dP|) of an increase in resistance (dR) to a change in pressure (dP) in pressurization is 0.15 Ω·cm²/MPa or less in the separator impregnated with a measurement electrolyte solution,
the measurement electrolyte solution contains an ethylene carbonate and an ethyl methyl carbonate as a solvent, and a lithium hexafluorophosphate as an electrolyte salt, a volume ratio between the ethylene carbonate and the ethyl methyl carbonate is 30:70, and the lithium hexafluorophosphate has a concentration of 1.0 mol/L.

2. (canceled)

3. A nonaqueous electrolyte energy storage device comprising:
a negative electrode containing silicon or tin; and
a separator,
wherein a value (dR/dP) of an increase in resistance (dR) to a change in pressure (dP) in pressurization is 0.15 Ω·cm²/MPa or less in the separator impregnated with a measurement electrolyte solution,
the measurement electrolyte solution contains an ethylene carbonate and an ethyl methyl carbonate as a solvent, and a lithium hexafluorophosphate as an electrolyte salt, a volume ratio between the ethylene carbonate and the ethyl methyl carbonate is 30:70, and the lithium hexafluorophosphate has a concentration of 1.0 mol/L.

4. A nonaqueous electrolyte energy storage device comprising:
a negative electrode containing silicon or tin; and
a separator,
wherein an absolute value (|dR/dP|) of an increase in resistance (dR) to a change in pressure (dP) in pressurization is 0.15 Ω·cm²/MPa or less in the separator impregnated with a measurement electrolyte solution,
the measurement electrolyte solution contains an ethylene carbonate and an ethyl methyl carbonate as a solvent, and a lithium hexafluorophosphate as an electrolyte salt, a volume ratio between the ethylene carbonate and the ethyl methyl carbonate is 30:70, and the lithium hexafluorophosphate has a concentration of 1.0 mol/L.

5. The nonaqueous electrolyte energy storage device according to claim 1, wherein the separator has an air permeability resistance of 250 seconds/100 mL or less.

6. The nonaqueous electrolyte energy storage device according to claim 1, wherein the separator includes a resin that has a glass transition point of 200° C. or lower.

7. The nonaqueous electrolyte energy storage device according to claim 1, wherein the separator contains a polyolefin.

8. The nonaqueous electrolyte energy storage device according to of claim 3, wherein the separator has an air permeability resistance of 250 seconds/100 mL or less.

9. The nonaqueous electrolyte energy storage device according to claim 3, wherein the separator includes a resin that has a glass transition point of 200° C. or lower.

10. The nonaqueous electrolyte energy storage device according to claim 3, wherein the separator contains a polyolefin.

11. The nonaqueous electrolyte energy storage device according to of claim 4, wherein the separator has an air permeability resistance of 250 seconds/100 mL or less.

12. The nonaqueous electrolyte energy storage device according to claim 4, wherein the separator includes a resin that has a glass transition point of 200° C. or lower.

13. The nonaqueous electrolyte energy storage device according to claim 4, wherein the separator contains a polyolefin.
